(19) United States
(12) Patent Application Publication
(10) Pub. No.: US 2026/0346753 A1
(43) Pub. Date: Nov. 5, 2026

(54) BATTERY EXCHANGE DEVICE, BATTERY EXCHANGE SYSTEM, AND BATTERY EXCHANGE METHOD

(71) Applicant: MITSUBISHI HEAVY INDUSTRIES, LTD., Tokyo (JP)

(72) Inventors: Megumu Tsuruta, Tokyo (JP); Tatsuya Sato, Tokyo (JP); Naoto Kawauchi, Tokyo (JP); Ei Onogawa, Tokyo (JP); Yasuhiro Kanai, Takasago City (JP); Ryo Matsumoto, Takasago City (JP); Kensuke Futahashi, Tokyo (JP)

(73) Assignee: MITSUBISHI HEAVY INDUSTRIES, LTD., Tokyo (JP)

(21) Appl. No.: 19/099,277

(22) PCT Filed: Sep. 4, 2023
(86) PCT No.: PCT/JP2023/032288

§ 371 Date: Jan. 28, 2025

(30) Foreign Application Priority Data
Sep. 22, 2022 (JP) 2022-151617

(51) Int. Cl. B60L 53/80; B60K 1/04; B60L 50/64

(52) U.S. Cl. CPC B60L 53/80; B60K 1/04; B60L 50/64; B60K 2001/0477; B60K 2001/0494; B60L 2200/42

(57) ABSTRACT

A battery exchange device includes: a loading table that is disposed to face a battery compartment in an advance/retreat direction of a transport vehicle and that has a first region and a second region where a pair of batteries are capable of being placed side by side in a width direction of the transport vehicle intersecting with the advance/retreat direction; a first moving mechanism that moves the loading table in the width direction to cause the first region and the second region to selectively face the battery compartment of the transport vehicle; a second moving mechanism that brings the loading table close to and away from the transport vehicle in the advance/retreat direction; and an actuator that is capable of drawing the battery from the battery compartment of the transport vehicle to the first region and inserting the battery on the second region into the battery compartment.

### TECHNICAL FIELD

The present disclosure relates to a battery exchange device, a battery exchange system, and a battery exchange method.

Priority is claimed on Japanese Patent Application No. 2022-151617, filed Sep. 22, 2022, the content of which is incorporated herein by reference.

### BACKGROUND ART

In the related art, PTL 1 discloses a system for exchanging a battery of a transport vehicle. This system includes a storage unit that stores a battery, a transport vehicle that includes a receiving part that receives an interchangeable battery, and a detachable device that transports the battery between the receiving unit of the transport vehicle and the storage unit.

### CITATION LIST

### Patent Literature

[PTL 1] Japanese Patent No. 5629312

### SUMMARY OF INVENTION

### Technical Problem

Meanwhile, such a transport vehicle is used, for example, to load and unload cargo on and from a shelf in a warehouse. In this case, the transport vehicle passes through, for example, a passage between the shelves. In recent years, in order to narrow the interval between the shelves to increase the storage capacity in the warehouse, it is required to design the transport vehicle to be as small as possible. In order to design the transport vehicle to be small, a plurality of batteries may be mounted on the transport vehicle by adopting small batteries. In this case, since the small battery has a short duration, it is necessary to frequently exchange the battery. Therefore, the long time required for battery exchange has been considered a problem.

The present disclosure has been made to solve the above-described problems, and an object of the present disclosure is to provide a battery exchange device, a battery exchange system, and a battery exchange method capable of shortening the time required for battery exchange.

### Solution to Problem

In order to achieve the above object, a battery exchange device according to the present disclosure is a battery exchange device of a transport vehicle including a battery compartment, the battery exchange device including a loading table that is disposed to face the battery compartment in an advance/retreat direction of the transport vehicle and that has a first region and a second region where a pair of batteries are capable of being placed side by side in a width direction of the transport vehicle intersecting with the advance/retreat direction; a first moving mechanism that moves the loading table in the width direction to cause the first region and the second region to selectively face the battery compartment of the transport vehicle; a second moving mechanism that brings the loading table close to and away from the transport vehicle in the advance/retreat direction; and an actuator that is capable of drawing the battery from the battery compartment of the transport vehicle to the first region and inserting the battery on the second region into the battery compartment.

A battery exchange system according to the present disclosure includes the above battery exchange device and the transport vehicle.

A battery exchange method according to the present disclosure is a battery exchange method for exchanging the battery in the battery compartment with the battery on the second region by using the above battery exchange device, the battery exchange method including a step of moving the loading table to dispose the first region facing the battery compartment to position the first region; a step of drawing the battery in the battery compartment onto the first region; a step of moving the loading table to dispose the second region facing the battery compartment to position the second region; and a step of inserting the battery on the second region into the battery compartment.

### Advantageous Effects of Invention

According to the battery exchange device, the battery exchange system, and the battery exchange method of the present disclosure, it is possible to shorten the time required for battery exchange.

### BRIEF DESCRIPTION OF DRAWINGS

FIG. 1 is a perspective view of a battery exchange system according to a first embodiment of the present disclosure.

FIG. 2 is a diagram illustrating a battery exchange system according to the first embodiment of the present disclosure as viewed from above.

FIG. 3 is a diagram illustrating a battery exchange device according to the first embodiment of the present disclosure as viewed in a width direction.

FIG. 4 is a functional block diagram illustrating a configuration of a control unit of the battery exchange device according to the first embodiment of the present disclosure.

FIG. 5 is a flowchart illustrating a procedure of a battery exchange method according to the first embodiment of the present disclosure.

FIG. 6 is a diagram illustrating a step of positioning a first region in the battery exchange method according to the first embodiment of the present disclosure.

FIG. 7 is a diagram illustrating a step of gripping a battery in a battery compartment in the battery exchange method according to the first embodiment of the present disclosure.

FIG. 8 is a diagram illustrating a step of drawing the battery in the battery compartment in the battery exchange method according to the first embodiment of the present disclosure.

FIG. 9 is a diagram illustrating a step of positioning a second region in the battery exchange method according to the first embodiment of the present disclosure.

FIG. 10 is a diagram illustrating a step of inserting a charged battery into the battery compartment in the battery exchange method according to the first embodiment of the present disclosure.

FIG. 11 is a diagram illustrating a step of separating an actuator from the battery compartment in the battery exchange method according to the first embodiment of the present disclosure.

FIG. 12 is a diagram illustrating a battery exchange system according to a second embodiment of the present disclosure.

FIG. 13 is a diagram illustrating a battery exchange system according to a third embodiment of the present disclosure.

FIG. 14 is a hardware configuration diagram illustrating a configuration of a computer according to each embodiment of the present disclosure.

FIG. 15 is a diagram illustrating an actuator according to another embodiment of the present disclosure.

FIG. 16 is a diagram illustrating an actuator according to another embodiment of the present disclosure.

FIG. 17 is a diagram illustrating an actuator according to another embodiment of the present disclosure.

FIG. 18 is a diagram illustrating an actuator according to another embodiment of the present disclosure.

FIG. 19 is a diagram illustrating an actuator according to another embodiment of the present disclosure.

### DESCRIPTION OF EMBODIMENTS

### First Embodiment

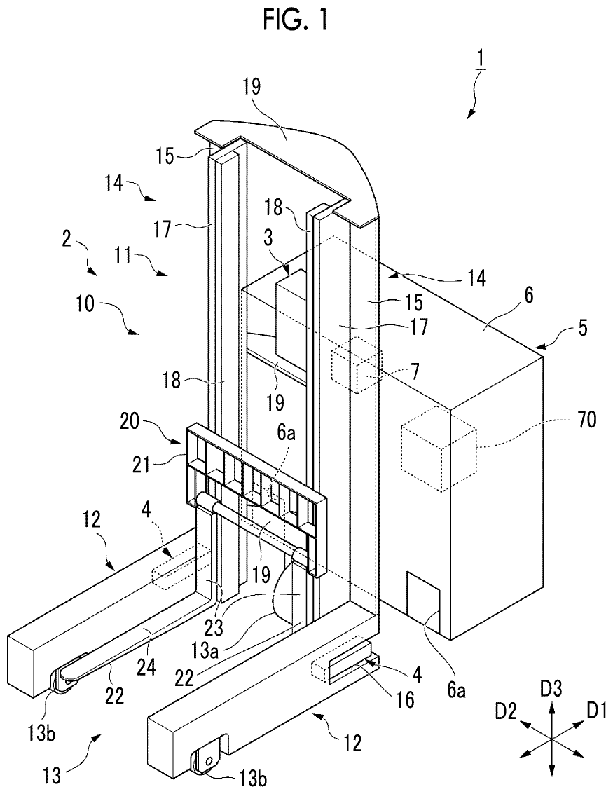

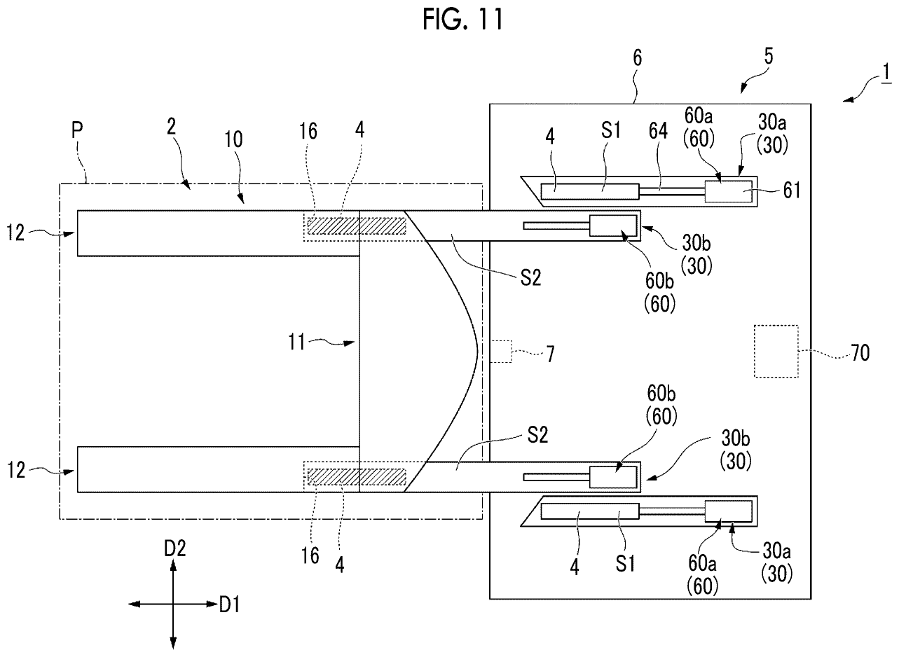

Hereinafter, a battery exchange device 5, a battery exchange system 1, and a battery exchange method according to a first embodiment of the present disclosure will be described with reference to FIGS. 1 to 11.

### Battery Exchange System

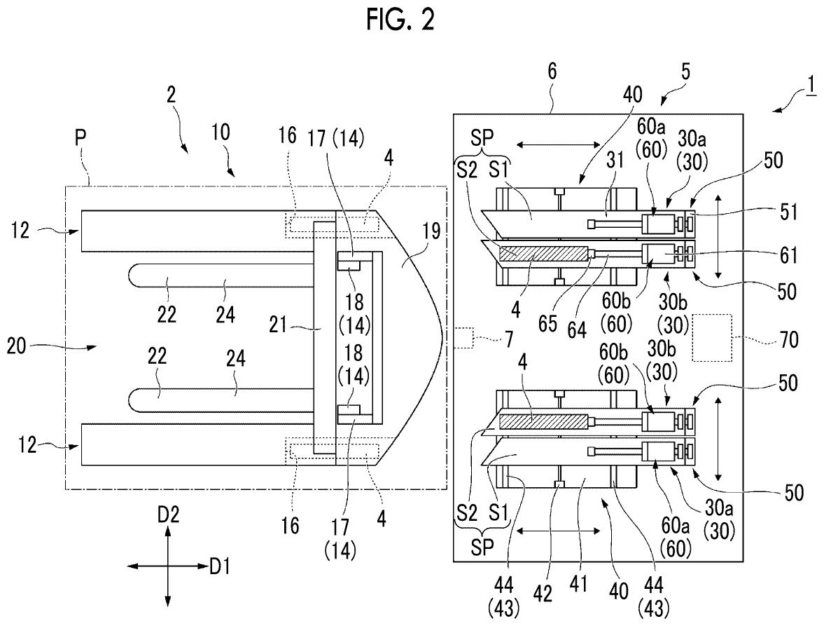

As illustrated in FIGS. 1 and 2, the battery exchange system 1 includes a transport vehicle 2 and a battery exchange device 5. The battery exchange system 1 is a system that exchanges a battery 4 of the transport vehicle 2 that performs loading and unloading work.

### Transport Vehicle

Examples of the transport vehicle 2 include logistics vehicles, industrial vehicles, and electric vehicles. The transport vehicle 2 according to the present embodiment is an automated driving forklift. The transport vehicle 2 according to the present embodiment performs loading and unloading work in a warehouse. A plurality of shelves for storing cargo are installed in the warehouse at intervals. The transport vehicle 2 runs on a passage between the shelves. The transport vehicle 2 is configured to be movable forward and backward at least in a forward-backward direction and to be turnable in a left-right direction.

In the following, an advance/retreat direction D1 of the transport vehicle 2 in a horizontal direction will be simply referred to as an “advance/retreat direction D1”, and a direction orthogonal to the advance/retreat direction D1 in the horizontal direction will be referred to as a “width direction D2”. The advance/retreat direction D1 and the width direction D2 are orthogonal to an up-down direction D3.

The transport vehicle 2 includes a vehicle 10, a loading and unloading device 20, a control device 3, and a battery 4.

### Vehicle

The vehicle 10 is a body portion of the transport vehicle 2. The vehicle 10 includes a vehicle body 11, a straddle leg 12, and a running mechanism 13.

### Vehicle Body

The vehicle body 11 includes a mast 14, a vehicle body frame 15, and a bracket 19.

The mast 14 includes an outer mast 17 and an inner mast 18. The outer masts 17 are provided in a pair to be spaced from each other in the width direction D2. The outer mast 17 extends in the up-down direction D3. One inner mast 18 is provided inside each outer mast 17 in the width direction D2. The inner masts 18 are provided in a pair to be spaced from each other in the width direction D2. The inner mast 18 is provided to be capable of being lifted and lowered in the up-down direction D3 with respect to the outer mast 17. In addition, the inner mast 18 is tiltable between a state in which the inner mast 18 extends vertically with respect to a horizontal plane along a vertical line and a state in which the inner mast 18 is inclined with respect to the vertical line by a tilt mechanism (not illustrated).

The vehicle body frames 15 are provided in a pair at an interval in the width direction D2. The vehicle body frame 15 extends in the up-down direction D3.

The bracket 19 is a plate-shaped member that connects the pair of vehicle body frames 15 in the width direction D2. A plurality of brackets 19 are provided to be spaced from each other in the up-down direction D3. A trailing edge of the bracket 19 is formed in a U shape that protrudes to a rear side in the advance/retreat direction D1 as viewed in the up-down direction D3.

### Straddle Leg

The straddle leg 12 is provided at a lower end of each vehicle body frame 15. The straddle legs 12 are provided in a pair to be spaced from each other in the width direction D2. The straddle leg 12 extends forward from the lower end of the vehicle body frame 15. A rear surface of the straddle leg 12 is curved so as to be positioned gradually backward toward the inside in the width direction D2 along the bracket 19. The outer mast 17 is attached to each straddle leg 12 so as to be movable relative to the straddle leg 12 in the advance/retreat direction D1. Examples of the configuration in which the outer mast 17 is attached to the straddle leg 12 so as to be movable relative to the straddle leg 12 include a configuration in which a rail (not illustrated) provided in the straddle leg 12 and extending in the advance/retreat direction D1 and a roller (not illustrated) provided in the outer mast 17 and movable in the advance/retreat direction D1 along the rail are provided.

In addition, a battery compartment 16 is provided in a rear end portion of each straddle leg 12.

### Battery Compartment

The battery compartment 16 is open on the rear side in the forward-backward direction. The battery 4, which will be described below, is accommodated in the battery compartment 16. A plurality of the battery compartments 16 are disposed side by side in the width direction D2 in one transport vehicle 2. In the present embodiment, the battery compartments 16 are provided in a pair so as to be spaced from each other in the width direction D2.

### Running Mechanism

The running mechanism 13 is provided in a lower portion of the vehicle body 11. The running mechanism 13 includes a first drive wheel 13a and a second drive wheel 13b. The first drive wheel 13a is provided on the bracket 19 at the lowermost end among the plurality of brackets 19. The second drive wheel 13b is provided in a front end portion of each straddle leg 12. In addition, each second drive wheel 13b is rotatable about a central axis extending in the width direction D2. The running mechanism 13 runs the vehicle body 11 by rotationally driving the first drive wheel 13a.

### Loading and Unloading Device

The loading and unloading device 20 is attached to the inner mast 18. The loading and unloading device 20 is a device that holds cargo to be transported and performs loading work and unloading work. The loading and unloading device 20 includes a lift bracket 21 and a fork 22. The lift bracket 21 is provided so as to bridge the pair of inner masts 18. The lift bracket 21 is adapted to be capable of being lifted and lowered with respect to the inner mast 18 in the up-down direction D3 by a lifting mechanism (not illustrated). In addition, the lift bracket 21 is movable in the advance/retreat direction D1 by an advancing and retreating mechanism (not illustrated). The lift bracket 21 extends in the up-down direction D3 and the width direction D2 and is formed in a lattice shape as viewed in the advance/retreat direction D1. The fork 22 is attached to the lift bracket 21. The fork 22 can be lifted and lowered in the up-down direction D3 integrally with the lift bracket 21 and is movable in the advance/retreat direction D1. The fork 22 is formed in an L shape as viewed in the width direction D2. The fork 22 includes a fork base portion 23 that extends in the up-down direction D3 and a fork claw portion 24 that extends forward from a lower end of the fork base portion 23. A front end portion of the fork claw portion 24 is inserted into a pallet (not illustrated) on which cargo to be transported is placed.

### Control Device

The control device 3 is installed, for example, in a middle bracket 19 in the up-down direction D3 among the plurality of brackets 19. The control device 3 controls various devices (running mechanism 13, loading and unloading device 20, and the like) of the transport vehicle 2.

### Battery

The battery 4 is accommodated in the battery compartment 16 of the straddle leg 12. The battery 4 supplies power to various devices (running mechanism 13, loading and unloading device 20, control device 3, and the like) of the transport vehicle 2. The battery 4 is designed to be smaller and lighter than a battery 4 in the related art. Therefore, the battery 4 has a short duration, and it is necessary to frequently exchange the battery 4. The transport vehicle 2 with a low remaining capacity of the battery 4 is parked in a parking region P located in front of the battery exchange device 5.

### Battery Exchange Device

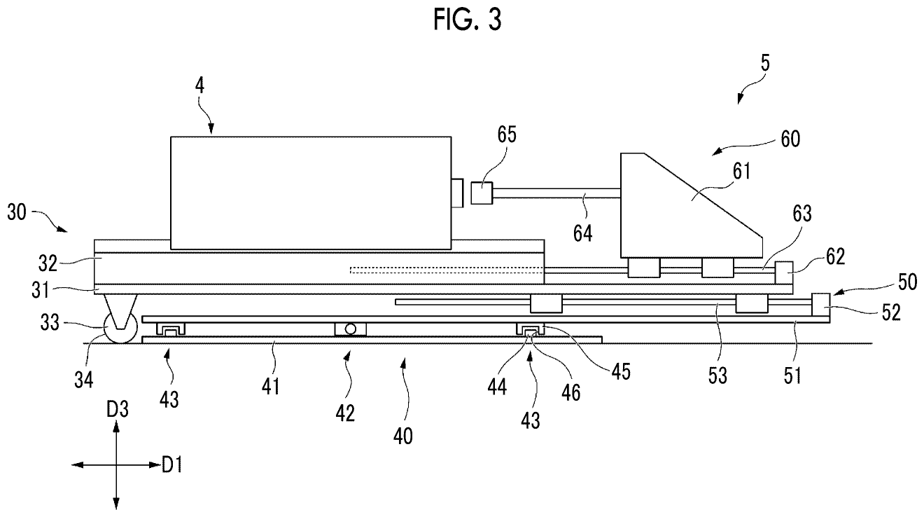

The battery exchange device 5 is a device that exchanges the battery 4 of the transport vehicle 2. The battery exchange device 5 is designed to have a size such that the battery exchange device 5 can be accommodated in, for example, a storage space for 11-type pallets. In addition, the battery exchange device 5 is designed to have a height such that the battery exchange device 5 can be accommodated in, for example, a general loading rack (not illustrated). The battery exchange device 5 can be disposed in any space in the warehouse as long as power can be supplied. As illustrated in FIGS. 2 and 3, the battery exchange device 5 includes a casing 6, a detection unit 7, a loading table 30, a first moving mechanism 40, a second moving mechanism 50, an actuator 60, and a control unit 70.

### Casing

The casing 6 is disposed behind the parking region P. The casing 6 is, for example, a box-shaped container extending in the up-down direction D3. The casing 6 is formed in a rectangular parallelepiped shape. An opening 6a that is open toward the front is formed on a front surface of a lower end portion of the casing 6. The openings 6a are formed in a pair on both sides of the casing 6 in the width direction D2. The opening 6a is used to insert and remove the battery 4. The casing 6 stores the detection unit 7, the loading table 30, the first moving mechanism 40, the second moving mechanism 50, the actuator 60, and the control unit 70.

### Detection Unit

The detection unit 7 is provided on the front surface of the casing 6. The detection unit 7 detects the transport vehicle 2 parked in the parking region P.

### Loading Table

The loading table 30 is disposed to face the opening 6a of the casing 6 in the advance/retreat direction D1. Therefore, the loading table 30 is disposed to face the battery compartment 16 of the transport vehicle 2 in the advance/retreat direction D1 of the transport vehicle 2. The loading table 30 is provided to be capable of being inserted into and removed from the casing 6 through the opening 6a by the second moving mechanism 50 to be described below. The loading table 30 is provided for each battery compartment 16. The loading table 30 has a first region S1 and a second region S2 where a pair of batteries 4 can be placed side by side in the width direction D2. In a case where the first region S1 and the second region S2 disposed side by side in the width direction D2 are referred to as a region pair SP, the region pair SP is provided for each battery compartment 16. In the present embodiment, the battery 4 with a low level of charge or the empty battery 4 that is taken out from the battery compartment 16 is placed in the first region S1, and the charged battery 4 is placed in the second region S2.

A plurality of loading tables 30 according to the present embodiment include a first loading table 30a having the first region S1 and a second loading table 30b having the second region S2. The first loading table 30a and the second loading table 30b have the same configuration. The loading table 30 includes a loading table body 31, a movable rail 32, and a caster portion 33.

The loading table body 31 is provided at a position spaced upward from a bottom surface of the casing 6. The loading table body 31 is a plate-shaped member extending in the advance/retreat direction D1. A front end portion of the loading table body 31 is curved along a rear surface of the transport vehicle 2.

The movable rail 32 is provided on an upper surface of the loading table body 31. The movable rail 32 guides the movement of the battery 4 in the advance/retreat direction D1.

The caster portion 33 is provided in a front end portion of the loading table body 31. The caster portion 33 is in contact with the bottom surface of the casing 6. A ground surface 34 of the caster portion 33 is formed in a spherical shape. Therefore, the caster portion 33 is rotatable in the advance/retreat direction D1 and the width direction D2.

### First Moving Mechanism

The first moving mechanism 40 is provided below the loading table 30. The first moving mechanism 40 moves the loading table 30 in the width direction D2 to cause the first region S1 and the second region S2 to selectively face the battery compartment 16 of the transport vehicle 2. The first moving mechanism 40 according to the present embodiment moves the loading table 30 in the width direction D2 for each second moving mechanism 50 to be described below. The first moving mechanism 40 is provided for each loading table 30. That is, the first moving mechanism 40 is provided for each region pair SP of the first region S1 and the second region S2. The first moving mechanism 40 includes a base 41, a first motor (not illustrated), a first ball screw 42, and a first linear guide unit 43.

The base 41 is provided on the bottom surface of the casing 6 and is positioned behind the caster portion 33. The base 41 is a rectangular plate-shaped member extending in the advance/retreat direction D1.

The first motor (not illustrated) is provided on the base 41 or the bottom surface of the casing 6.

The first ball screw 42 is provided on the base 41. The first ball screw 42 moves the second moving mechanism 50 to be described below and the loading table 30 placed on the second moving mechanism 50 in the width direction D2 by means of the driving force of the first motor.

The first linear guide unit 43 suppresses the deviation of the second moving mechanism 50 and the loading table 30 in the advance/retreat direction D1 in a case where the second moving mechanism 50 and the loading table 30 move in the width direction D2. The first linear guide units 43 are provided on both sides of the first ball screw 42 in the advance/retreat direction D1. The first linear guide unit 43 includes a rail 44 and a guide portion 45. The rail 44 is provided on the base 41 and is formed in a rod shape extending in the width direction D2. The guide portion 45 is provided below the second moving mechanism 50 and extends along the rail 44 in the width direction D2. A guide groove 46 is formed in a lower surface of the guide portion 45. The guide groove 46 is formed in a U shape that is open downward and that is open downward as viewed in the width direction D2. The rail 44 is disposed in the guide groove 46. In a case where the second moving mechanism 50 and the loading table 30 have been moved in the width direction D2 by the first ball screw 42, the guide portion 45 also moves in the width direction D2 along the rail 44.

### Second Moving Mechanism

The second moving mechanism 50 is provided below the loading table 30 and above the first moving mechanism 40. The second moving mechanism 50 brings the loading table 30 close to and away from the transport vehicle 2 in the advance/retreat direction D1. The second moving mechanism 50 is provided for each loading table 30. That is, the second moving mechanism 50 is provided for each region pair SP of the first region S1 and the second region S2. The second moving mechanism 50 includes a table 51, a second motor 52, a second ball screw 53, and a second linear guide unit (not illustrated).

The table 51 is provided above the first moving mechanism 40. The table 51 is provided for each of the first region S1 and the second region S2. The table 51 is a plate-shaped member extending in the advance/retreat direction D1. The first ball screw 42 is connected to a lower surface of the table 51. In addition, the guide portion 45 of the first linear guide unit 43 is provided on the lower surface of the table 51.

The second motor 52 is provided on an upper surface of a rear end portion of the table 51.

The second ball screw 53 extends forward from the second motor 52. The second ball screw 53 is connected to the loading table body 31. The second ball screw 53 moves the loading table 30 in the advance/retreat direction D1 by means of the driving force of the second motor 52.

The second linear guide units (not illustrated) are provided on both outer sides of the second ball screw 53 in the width direction D2 and extend in the advance/retreat direction D1. The second linear guide unit suppresses the deviation of the loading table 30 in the width direction D2 in a case where the loading table 30 moves in the advance/retreat direction D1. The second linear guide units have the same configuration as the first linear guide unit 43.

### Actuator

The actuator 60 is provided on the loading table 30. The actuator 60 can draw the battery 4 from the battery compartment 16 to the first region S1 and can insert the battery 4 on the second region S2 into the battery compartment 16. In the present embodiment, one actuator 60 is provided so as to be disposed to face each of the first region S1 and the second region S2 in the advance/retreat direction D1. Hereinafter, the actuator 60 that is disposed to face the first region S1 in the advance/retreat direction D1 will be referred to as a first actuator 60a, and the actuator 60 that is disposed to face the second region S2 in the advance/retreat direction D1 will be referred to as a second actuator 60b. The first actuator 60a and the second actuator 60b have the same configuration.

The actuator 60 includes an actuator base portion 61, a third motor 62, a third ball screw 63, a third linear guide unit (not illustrated), an arm 64, and a tool changer 65.

The actuator base portion 61 is a block-shaped member provided above the loading table body 31. The actuator base portion 61 is provided in a rear portion of the loading table body 31. For example, the actuator base portion 61 has an inclined surface, which is inclined downward toward the rear side, at an upper portion thereof. The shape of the actuator base portion 61 is not limited, and the actuator base portion 61 may not have the inclined surface on the upper portion.

The third motor 62 is provided on an upper surface of a rear end portion of the loading table body 31.

The third ball screw 63 extends forward from the third motor 62. The third ball screw 63 is connected to the actuator base portion 61. The third ball screw 63 moves the actuator base portion 61 in the advance/retreat direction D1 by means of the driving force of the third motor 62.

The third linear guide units (not illustrated) are provided on both outer sides of the third ball screw 63 in the width direction D2 and extend in the advance/retreat direction D1. The third linear guide unit suppresses the deviation of the actuator base portion 61 in the width direction D2 in a case where the actuator base portion 61 moves in the advance/retreat direction D1. The third linear guide unit has the same configuration as the first linear guide unit 43.

The arm 64 extends from a front surface of the actuator base portion 61 to the front side in the advance/retreat direction D1. The arm 64 is designed to be extendable forward and backward in the advance/retreat direction D1.

The tool changer 65 is provided in a front end portion of the arm 64. The tool changer 65 is a member that grips the battery 4.

The actuator 60 can move the battery 4 in the advance/retreat direction D1 by driving the third motor 62 in a state in which the battery 4 is gripped by the tool changer 65. The second actuator 60b of the actuators 60 grips the battery 4 on the second region S2 in advance.

The actuator 60, the detection unit 7, the first moving mechanism 40, and the second moving mechanism 50 described above are controlled by the control unit 70.

### Control Unit

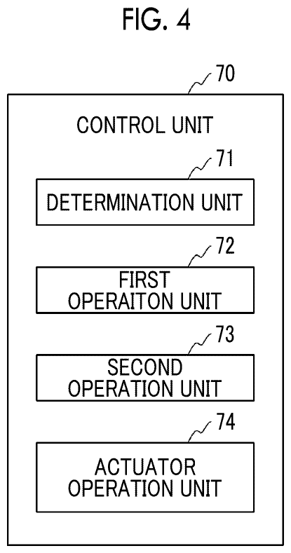

As illustrated in FIG. 4, the control unit 70 includes a determination unit 71, a first operation unit 72, a second operation unit 73, and an actuator operation unit 74.

The determination unit 71 determines whether or not the entire transport vehicle 2 has arrived at the parking region P.

The first operation unit 72 moves the loading table 30 in the width direction D2 via the first moving mechanism 40.

The second operation unit 73 moves the loading table 30 in the advance/retreat direction D1 via the second moving mechanism 50.

The actuator operation unit 74 operates the actuator 60. Specifically, the actuator operation unit 74 operates the tool changer 65 to cause the actuator 60 to grip the battery 4 or to release the grip of the battery 4. In addition, the actuator operation unit 74 moves the battery 4 in the advance/retreat direction D1 by moving the actuator 60 that has gripped the battery 4 in the advance/retreat direction D1. In addition, the actuator operation unit 74 extends the arm 64 of the actuator 60 in the advance/retreat direction D1.

Although not illustrated in the drawings, the battery exchange device 5 includes a charger that charges the battery 4, a disposition space that stores the charged battery 4, and a device that places the battery 4 on the loading table 30 or takes out the battery 4 from the loading table 30. The charger or the charged battery 4 is disposed, for example, between the two first moving mechanisms 40.

### Procedure of Battery Exchange Method

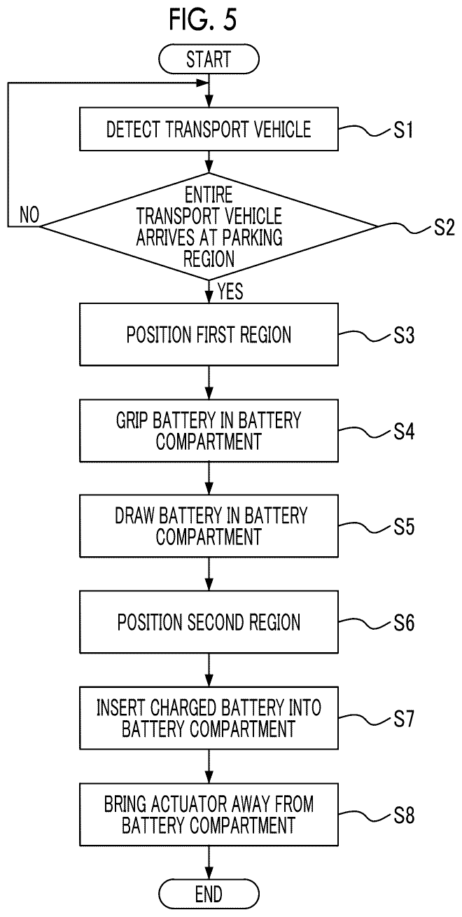

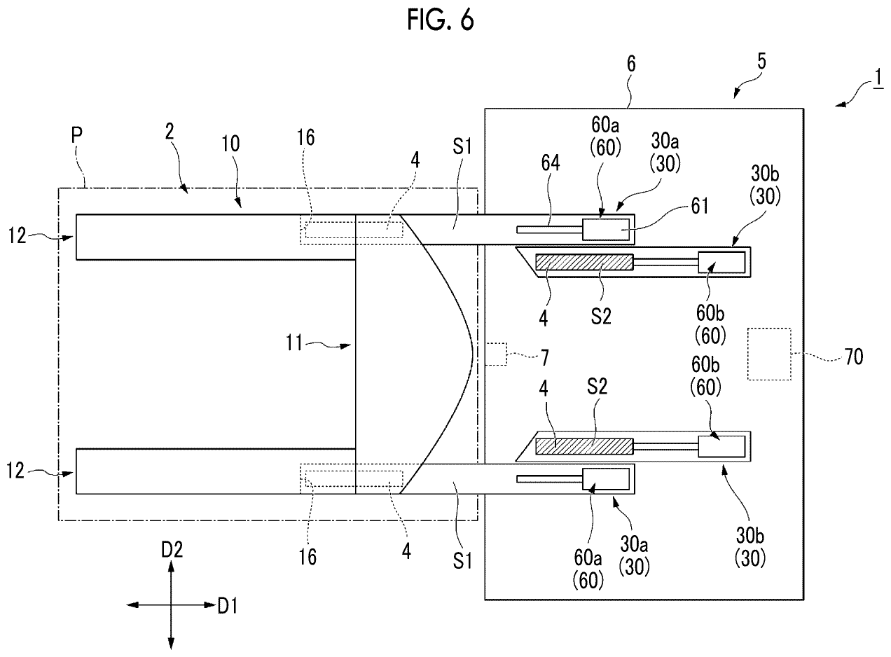

Hereinafter, a procedure of the battery exchange method according to the present embodiment will be described with reference to a flowchart of FIG. 5 and FIGS. 6 to 11. In FIGS. 6 to 11, the configuration of the battery exchange system 1 is simplified, and a part of the configuration is omitted.

In the battery exchange method of the present embodiment, the first moving mechanisms 40, the second moving mechanisms 50, and the loading tables 30 on both the left and right sides are all operated at the same time.

First, the detection unit 7 detects the transport vehicle 2 (Step S1). After Step S1, the determination unit 71 determines whether or not the entire transport vehicle 2 has arrived at the parking region P (Step S2). In a case where the entire transport vehicle 2 has not arrived at the parking region P (Step S2; NO), the process returns to the detection of the transport vehicle 2 (Step S1). In a case where the entire transport vehicle 2 has arrived at the parking region P (Step S2; YES), the battery exchange device 5 positions the first region S1 as illustrated in FIG. 6 (Step S3).

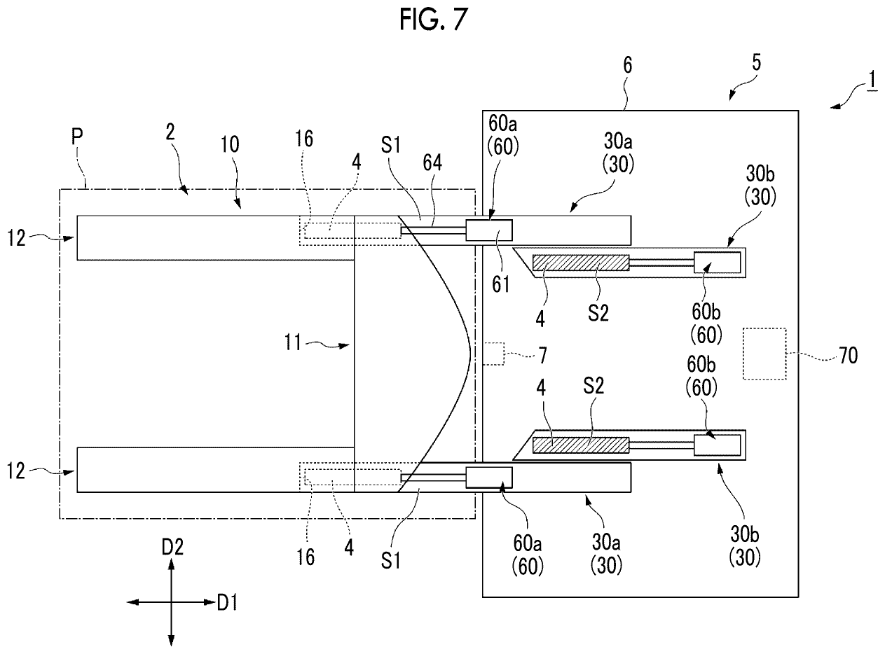

In Step S3, the battery exchange device 5 moves the first loading table 30a to dispose the first region S1 facing the battery compartment 16. First, the first operation unit 72 moves the first loading table 30a and the second loading table 30b in the width direction D2 via the first moving mechanism 40. Accordingly, the first region S1 is positioned in the width direction D2, and the first region S1 is disposed at a position facing the battery compartment 16 in the advance/retreat direction D1. Subsequently, the second operation unit 73 moves the first loading table 30a to the front side in the advance/retreat direction D1 by the second moving mechanism 50. Accordingly, the first region S1 is positioned in the advance/retreat direction D1, and the first region S1 is brought close to the battery compartment 16 in the advance/retreat direction D1. Step S3 takes, for example, about 5 seconds. In addition, in Step S3, the arm 64 of the first actuator 60a is extended to an upper limit thereof. After Step S3, as illustrated in FIG. 7, the first actuator 60a grips the battery 4 in the battery compartment 16 (Step S4).

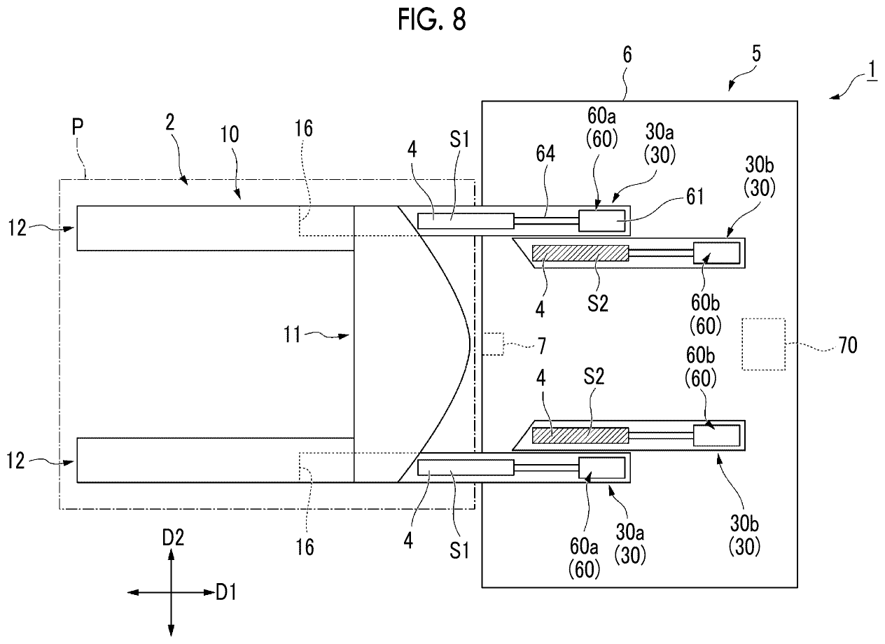

In Step S4, the actuator operation unit 74 operates the first actuator 60a to insert the arm 64 of the first actuator 60a into the battery compartment 16. Then, the transport vehicle 2 switches to a state in which the battery 4 is detachable from the battery compartment 16, and the first actuator 60a grips the battery 4 with the tool changer 65. As the battery 4 is gripped, the battery 4 is unlocked. Step S4 takes, for example, about 3 seconds. After Step S4 is completed, as illustrated in FIG. 8, the actuator 60 draws the battery 4 in the battery compartment 16 onto the first region S1 (Step S5).

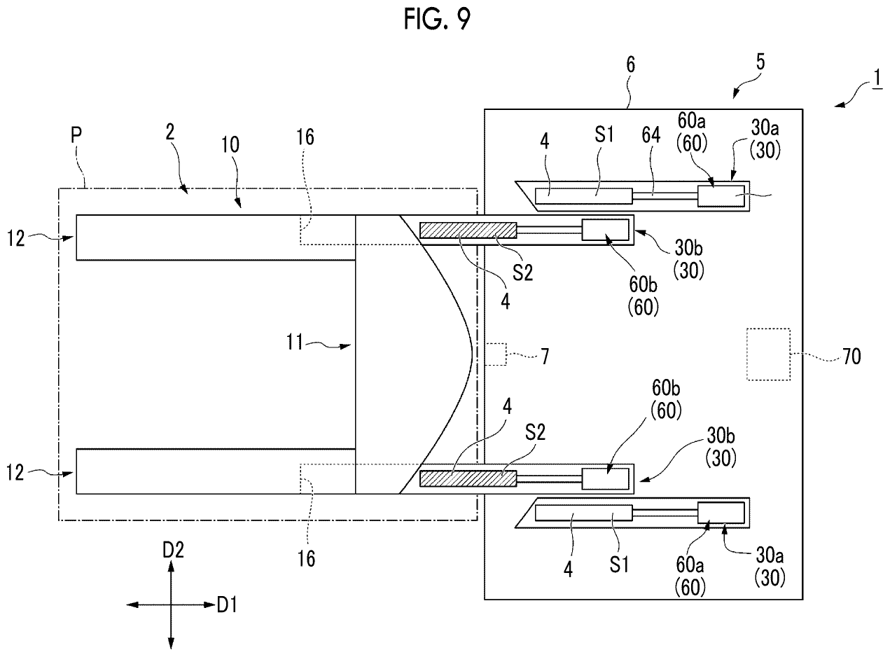

In Step S5, the actuator operation unit 74 operates the actuator 60 to move the actuator 60 in the advance/retreat direction D1 to the rear side in a state in which the battery 4 is gripped. In this way, the battery 4 in the battery compartment 16 is drawn. Then, the first operation unit 72 moves the first loading table 30a to the rear side in the advance/retreat direction D1 via the second moving mechanism 50. Accordingly, the first region S1 is spaced from the battery compartment 16 in the advance/retreat direction D1. Step S5 takes, for example, about 3 seconds. After Step S5, as illustrated in FIG. 9, the battery exchange device 5 positions the second region S2 (Step S6).

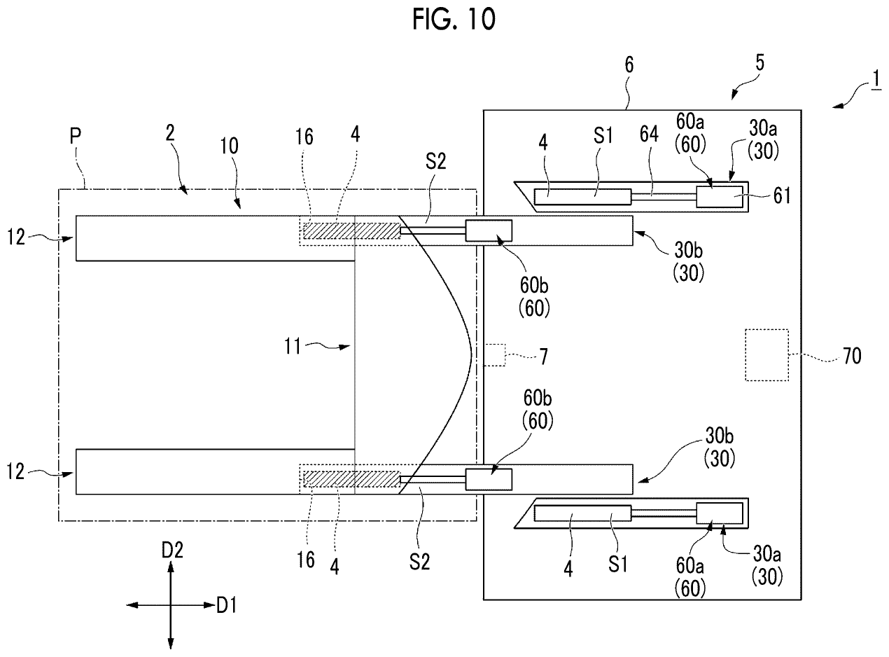

In Step S6, the battery exchange device 5 moves the second loading table 30b to dispose the second region S2 to face the battery compartment 16. First, the first operation unit 72 moves the second loading table 30b and the first loading table 30a in the width direction D2 via the first moving mechanism 40. Accordingly, the second region S2 is positioned in the width direction D2, and the second region S2 is disposed at a position facing the battery compartment 16 in the advance/retreat direction D1. Subsequently, the second operation unit 73 moves the second loading table 30b to the front side in the advance/retreat direction D1 via the second moving mechanism 50. Accordingly, the second region S2 is positioned in the advance/retreat direction D1, and the second region S2 is brought closer to the battery compartment 16 in the advance/retreat direction D1. Step S6 takes, for example, about 3 seconds. After Step S6, as illustrated in FIG. 10, the second actuator 60b inserts the charged battery 4 on the second region S2 into the battery compartment 16 (Step S7).

In Step S7, the actuator operation unit 74 operates the second actuator 60b to insert the arm 64 of the second actuator 60b into the battery compartment 16. The tool changer 65 of the second actuator 60b grips the battery 4 that has been charged in advance. Therefore, the charged battery 4 is inserted into the battery compartment 16 in this Step S7. In a case where the battery 4 is inserted into the battery compartment 16, the battery 4 is pushed by the arm 64 and mounted in the transport vehicle 2. In a case where the battery 4 is mounted in the transport vehicle 2, the battery 4 is locked in the battery compartment 16. Step S7 takes, for example, about 5 seconds. After Step S7, the actuator operation unit 74 moves the actuator 60 to the rear side in the advance/retreat direction D1, and the actuator 60 is spaced from the battery compartment 16 to the rear side in the advance/retreat direction D1 (Step S8). The battery compartment 16 is switched to a state in which the transport vehicle 2 can supply power to the battery 4. The switching of the battery 4 takes, for example, about 1 second. At this point, the transport vehicle 2 starts running and leaves the parking region P. It takes, for example, about 20 seconds from the arrival of the transport vehicle 2 to the start of running of the transport vehicle 2.

After Step S8, the second operation unit 73 moves the second loading table 30b to the rear side in the advance/retreat direction D1 via the second moving mechanism 50.

In this way, the battery is exchanged. Thereafter, the battery 4 drawn from the battery compartment 16 on the first loading table 30a is detached and inserted into a charger (not illustrated), and the charged battery 4 is placed on the second region S2 to prepare for the next battery exchange.

### Working Effects

The battery exchange device 5 according to the present embodiment exhibits the following working effects.

In the present embodiment, the battery exchange device 5 includes the loading table 30, the first moving mechanism 40, the second moving mechanism 50, and the actuator 60. The loading table 30 is disposed to face the battery compartment 16 in the advance/retreat direction D1 of the transport vehicle 2, and has the first region S1 and the second region S2 where a pair of batteries 4 can be placed side by side in the width direction D2 of the transport vehicle 2 intersecting the advance/retreat direction D1. The first moving mechanism 40 moves the loading table 30 in the width direction D2 to cause the first region S1 and the second region S2 to selectively face the battery compartment 16 of the transport vehicle 2. The second moving mechanism 50 brings the loading table 30 close to and away from the transport vehicle 2 in the advance/retreat direction D1. The actuator 60 can draw the battery 4 from the battery compartment 16 of the transport vehicle 2 in the first region S1 and can insert the battery 4 on the second region S2 into the battery compartment 16.

Since the battery 4 in the battery compartment 16 is exchanged with the charged battery 4, the battery exchange device 5 according to the present embodiment operates as follows. The battery 4 that has been charged in advance is placed on the second region S2. First, the battery exchange device 5 moves the loading table 30 in the width direction D2 and the advance/retreat direction D1 via the first moving mechanism 40 and the second moving mechanism 50 to dispose the first region S1 to face the battery compartment 16, and positions the first region S1. Subsequently, the battery exchange device 5 draws the battery 4 in the battery compartment 16 onto the first region S1 via the actuator 60. Subsequently, the battery exchange device 5 moves the loading table 30 in the width direction D2 and the advance/retreat direction D1 via the first moving mechanism 40 and the second moving mechanism 50 to dispose the second region S2 facing the battery compartment 16 to position the second region S2. Then, the battery exchange device 5 inserts the battery 4 on the second region S2 into the battery compartment 16 via the actuator 60. In this way, the battery 4 is exchanged.

As described above, according to the present embodiment, the battery exchange device 5 can smoothly exchange the battery 4 in the battery compartment 16 with the charged battery 4 placed in advance on the second region S2. Accordingly, the time required for battery exchange can be shortened.

In the present embodiment, a plurality of the actuators 60 are provided, and the plurality of actuators 60 include the first actuator 60a that is disposed to face the first region S1 in the advance/retreat direction D1 and the second actuator 60b that is disposed to face the second region S2 in the advance/retreat direction D1.

In the present embodiment, the charged battery 4 can be made to be gripped by the second actuator 60b in advance. Accordingly, the battery exchange device 5 can insert the battery 4 into the battery compartment 16 via the second actuator 60b immediately after the second region S2 and the battery compartment 16 are disposed to face each other in the advance/retreat direction D1. Thus, it is possible to further shorten the time required for battery exchange.

In the present embodiment, the plurality of battery compartments 16 are disposed side by side in the width direction D2 in the transport vehicle 2, and the region pair SP of the first region S1 and the second region S2 disposed side by side in the width direction D2 is provided for each battery compartment 16.

Accordingly, the battery exchange device 5 can exchange the battery 4 in the plurality of battery compartments 16 with the charged battery 4 at almost the same time. Thus, even in a case where a plurality of batteries 4 are provided in the transport vehicle 2, the time required for battery exchange can be further shortened.

In the present embodiment, the first moving mechanism 40 is provided for each region pair SP.

Accordingly, the battery exchange device 5 can control the movement of the loading table 30 in the width direction D2 for each region pair SP. Thus, the exchange accuracy of the battery exchange device 5 can be improved.

In the first embodiment, the case where the battery exchange device 5 is applied to the transport vehicle 2 in which a pair of battery compartments 16 are provided to be spaced from each other in the width direction D2 has been described, but the present disclosure is not limited thereto. For example, the battery exchange device 5 according to the present embodiment may be applied to the transport vehicle 2 in which only one battery compartment 16 is provided or to the transport vehicle 2 in which three or more battery compartments 16 are provided to be spaced from each other in the width direction D2.

### Second Embodiment

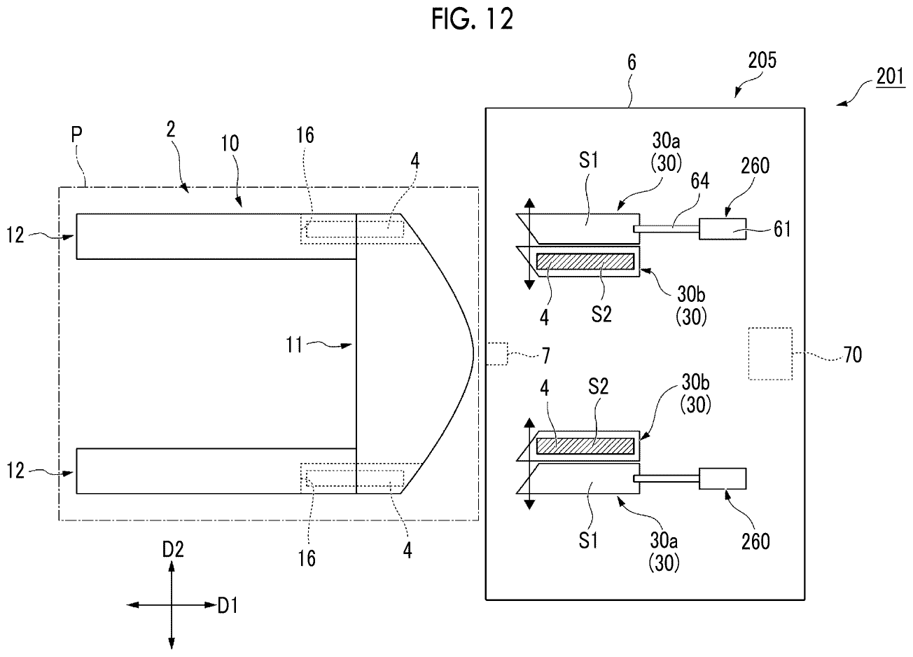

Hereinafter, a battery exchange system 201 and a battery exchange device 205 according to a second embodiment of the present disclosure will be described with reference to FIG. 12. The same configurations as those in the first embodiment will be given the same names and the same reference numerals, and description thereof will be omitted as appropriate. In FIG. 12, the configuration of the battery exchange system 201 is simplified, and a part of the configuration is omitted.

As illustrated in FIG. 12, in the present embodiment, only one actuator 260 is provided for one battery compartment 16. The battery exchange device 205 moves the loading table 30 in the width direction D2 to select whether to dispose the actuator 260 and the first region S1 to face each other in the advance/retreat direction D1 or to dispose the actuator 260 and the second region S2 to face each other in the advance/retreat direction D1. In a case where the actuator 260 and the first region S1 are disposed to face each other in the advance/retreat direction D1, the actuator 260 is operated to draw the battery 4 in the battery compartment 16 onto the first region S1. Meanwhile, in a case where the actuator 260 and the second region S2 are disposed to face the advance/retreat direction D1, the actuator 260 is operated to insert the battery 4 on the second region S2 into the battery compartment 16.

### Working Effects

According to the battery exchange device 205 of the present embodiment, the following working effects are exhibited.

In the present embodiment, only one actuator 260 is provided for one battery compartment 16.

Accordingly, the number of actuators 260 can be minimized. Thus, it is possible to reduce the cost of the battery exchange device 205 compared to a case where a plurality of actuators 260 are provided for one battery compartment 16.

### Third Embodiment

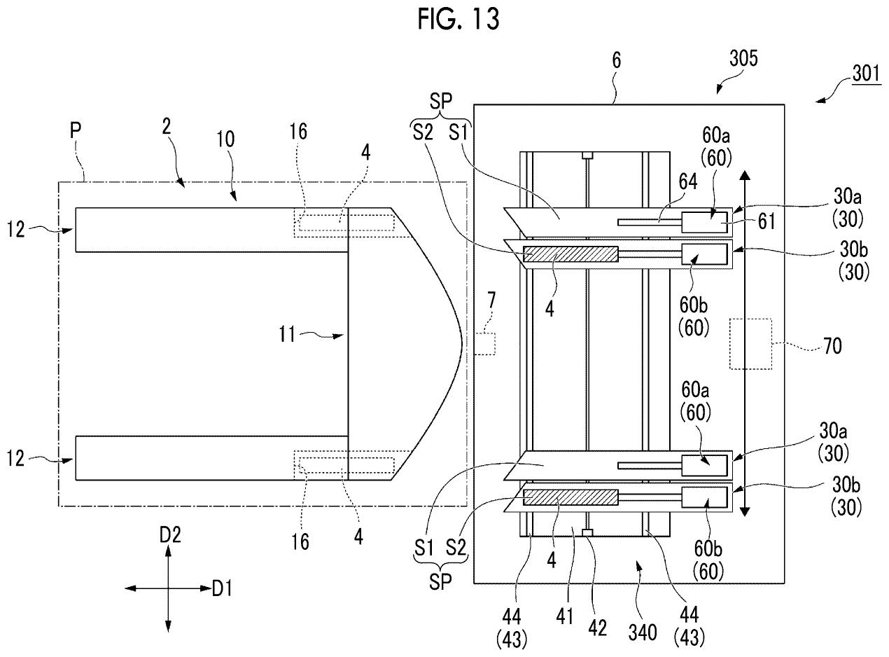

Hereinafter, a battery exchange system 301 and a battery exchange device 305 according to a third embodiment of the present disclosure will be described with reference to FIG. 13. The same configurations as those in the first embodiment will be given the same names and the same reference numerals, and description thereof will be appropriately omitted. In FIG. 13, the configuration of the battery exchange system 301 is simplified, and a part of the configuration is omitted.

As illustrated in FIG. 13, in the present embodiment, a first moving mechanism 340 is provided such that all pairs of the first loading table 30a and the second loading table 30b disposed side by side in the width direction D2 can be uniformly operated in the width direction D2. That is, the first moving mechanism 340 is provided to be capable of uniformly operating all the region pairs SP of the first region S1 and the second region S2 in the width direction D2. In addition, for all region pairs SP that are uniformly operated by the first moving mechanism 340, the disposition relationship between the first region S1 and the second region S2 in the width direction D2 is set to be the same disposition relationship. For example, from a viewpoint of the transport vehicle 2, the first region S1 is disposed on the right side in the width direction D2, and the second region S2 is disposed on the left side in the width direction D2.

### Working Effects

The battery exchange device 305 according to the present embodiment exhibits the following working effects.

In the present embodiment, the first moving mechanism 340 is provided to be capable of uniformly operating all the region pairs SP in the width direction D2, and the disposition relationship between the first region S1 and the second region S2 in the width direction D2 is the same disposition relationship for all the region pairs SP uniformly operated by the first moving mechanism 340.

Accordingly, the battery exchange device 305 can move all the region pairs SP via one first moving mechanism 340. Thus, the control of the battery exchange device 305 can be simplified. Therefore, it is possible to further reduce the cost of the battery exchange device 305.

In the third embodiment, while all the region pairs SP are provided to be capable of being uniformly operated in the width direction D2 via one first moving mechanism 340, the present disclosure is not limited thereto. For example, in a case in which three or more region pairs SP are present, only some of a plurality of region pairs SP may be provided to be capable of being uniformly operated in the width direction D2 by one first moving mechanism 340.

In the third embodiment, the first region S1 is disposed on the right side in the width direction D2, and the second region S2 is disposed on the left side in the width direction D2. However, the present disclosure is not limited thereto. The first region S1 may be disposed on the left side in the width direction D2, and the second region S2 may be disposed on the right side in the width direction D2.

### Hardware Configuration

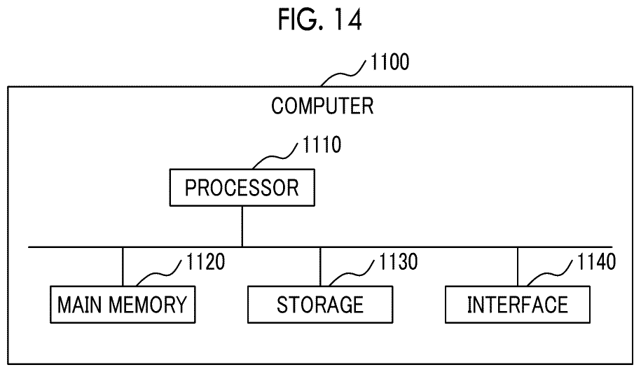

The control unit 70 according to each of the embodiments described above is mounted in a computer 1100 illustrated in FIG. 14. The computer 1100 includes a processor 1110, a main memory 1120, a storage 1130, and an interface 1140.

The operation of each functional unit of the control unit 70 described above is stored in the storage 1130 in the form of a program. The processor 1110 reads the program from the storage 1130, deploys the read program in the main memory 1120, and executes the above-described process in accordance with the program. In addition, the processor 1110 allocates a storage area corresponding to each storage unit described above in the main memory 1120 in accordance with the program.

The program may be a program for realizing some of the functions fulfilled by the computer 1100. For example, the program may exhibit the function in combination with another program already stored in the storage 1130 or in combination with another program implemented in another device. In addition, the computer 1100 may include a custom large-scale integrated circuit (LSI) such as a programmable logic device (PLD) in addition to or in place of the above configuration. Examples of the PLDs include a programmable array logic (PAL), a generic array logic (GAL), a complex programmable logic device (CPLD), and a field-programmable gate array (FPGA). In this case, some or all of the functions realized by the processor 1110 may be realized by the integrated circuit.

As an example of the storage 1130, a magnetic disk, a magneto-optical disk, or a semiconductor memory can be used. The storage 1130 may be an internal medium directly connected to a bus of the computer 1100 or may be an external medium connected to the computer 1100 through the interface 1140 or a communication line. In addition, when this program is distributed to the computer 1100 via the communication line, the computer 1100 receiving the distributed program may deploy the program in the main memory 1120 to execute the above-described process. The storage 1130 may be a non-temporary tangible storage medium.

Additionally, the program may be for realizing some of the aforementioned functions. In addition, the program may be a so-called difference file (difference program) that realizes the above-described functions in combination with another program previously stored in the storage 1130.

### Other Embodiments

The embodiments of the present disclosure have been described in detail hereinabove with reference to the drawings; however, specific configurations are not limited to the embodiments, and design changes and the like within a scope that does not deviate from the gist of the present disclosure are also included.

In the above-described embodiments, the case where the mast 14 is a two-stage mast having the outer mast 17 and the inner mast 18 has been described. However, the present disclosure is not limited thereto. This is merely an example of a configuration of the forklift. The mast 14 may be, for example, a multi-stage mast having three or more stages.

In the above-described embodiments, the battery exchange device 5 is designed to have a size such that the battery exchange device 5 can be accommodated in, for example, a storage space for an 11-type pallet, but the present disclosure is not limited thereto. The size of the battery exchange device 5 can be appropriately changed.

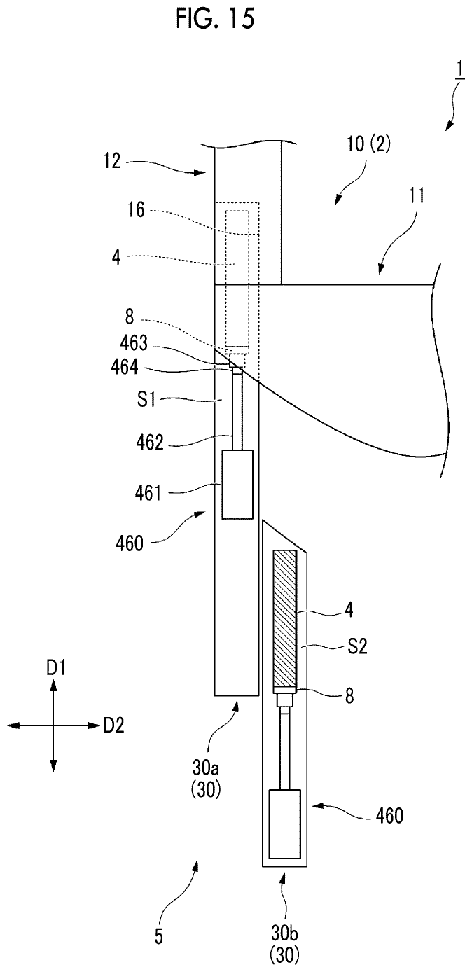

In addition, as illustrated in FIG. 15, the battery exchange device 5 may include an actuator 460 that grips the battery 4 by means of magnetic force. The actuator 460 includes an actuator base portion 461, an arm 462, a magnet catch 463, and a flexible joint 464.

The actuator base portion 461 is attached to the loading table 30 so as to be movable in the advance/retreat direction D1. For example, the actuator base portion 461 is provided with the third motor 62 and the third ball screw 63 in the same manner as the actuator base portion 61 of the first embodiment, and the third ball screw 63 may move the actuator base portion 461 in the advance/retreat direction D1 by means of the driving force of the third motor 62.

The arm 462 extends from the actuator base portion 461 to a front side (opening 6a side) in the advance/retreat direction D1. The arm 462 is provided to be extendable and retractable in the advance/retreat direction D1.

The magnet catch 463 is provided at a front end of the arm 462. The magnet catch 463 attracts a metal portion of the battery 4 by means of magnetic force. In the present embodiment, the battery 4 has, for example, an iron plate 8 at a rear end thereof. The magnet catch 463 grips the battery 4 by attracting the iron plate 8 by means of magnetic force.

The flexible joint 464 connects the arm 462 and the magnet catch 463. The flexible joint 464 is a member that is easily deformed in the advance/retreat direction D1, the width direction D2, and the up-down direction D3. Even in a case where the battery 4 is slightly inclined with respect to the arm 462, the flexible joint 464 can be deformed to bring the magnet catch 463 into contact with the rear surface of the battery 4 from the front in the advance/retreat direction D1. Accordingly, the magnet catch 463 can grip the battery 4 regardless of the inclination of the battery 4.

In the present embodiment, the actuator 460 includes the magnet catch 463 that attracts the battery 4 by means of magnetic force.

The actuator 460 attracts and grips the iron plate 8 of the battery 4 by means of magnetic force. Accordingly, the actuator 460 can powerfully grip the battery 4. Thus, it is possible to stably perform battery exchange.

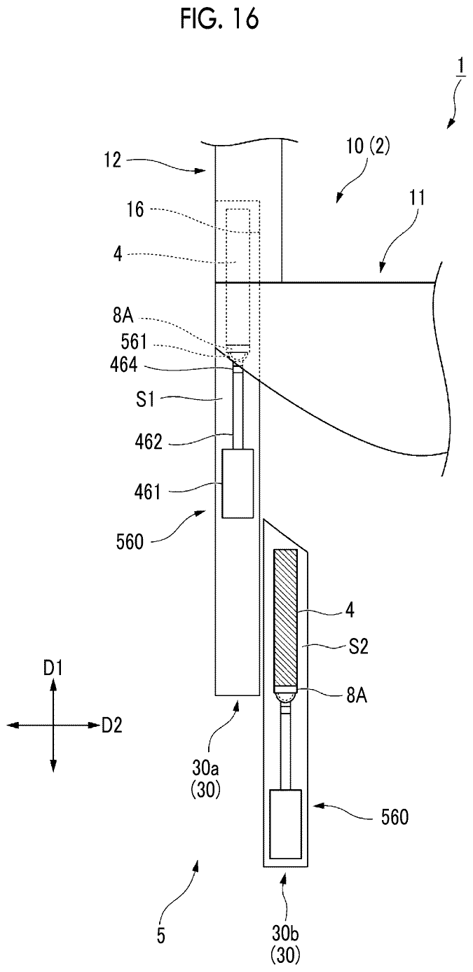

In addition, as illustrated in FIG. 16, an actuator 560 may grip the battery 4 by means of air pressure. The actuator 560 includes a suction cup 561 instead of the magnet catch 463 of the actuator 460 described above. The suction cup 561 is connected to the arm 462 by the flexible joint 464. The suction cup 561 is formed in a bottomed cylindrical shape (bowl shape) that is open toward the front side in the advance/retreat direction D1. The actuator 560 attracts the battery 4 by means of air pressure by creating negative pressure inside the suction cup 561 in a state in which an opening of the suction cup 561 is brought into close contact with the battery 4 from the rear side in the advance/retreat direction D1. In addition, an acrylic plate 8A is provided at an end portion of the battery 4 on the rear side in the advance/retreat direction D1. The acrylic plate 8A is formed in a flat plate shape. With the acrylic plate 8A, the suction cup 561 can be brought into close contact with the battery 4 without a gap.

As described above, in the present embodiment, the actuator 560 can grip the battery 4 by means of air pressure. Therefore, the actuator 560 can grip the battery 4 regardless of the material of the exterior of the battery 4.

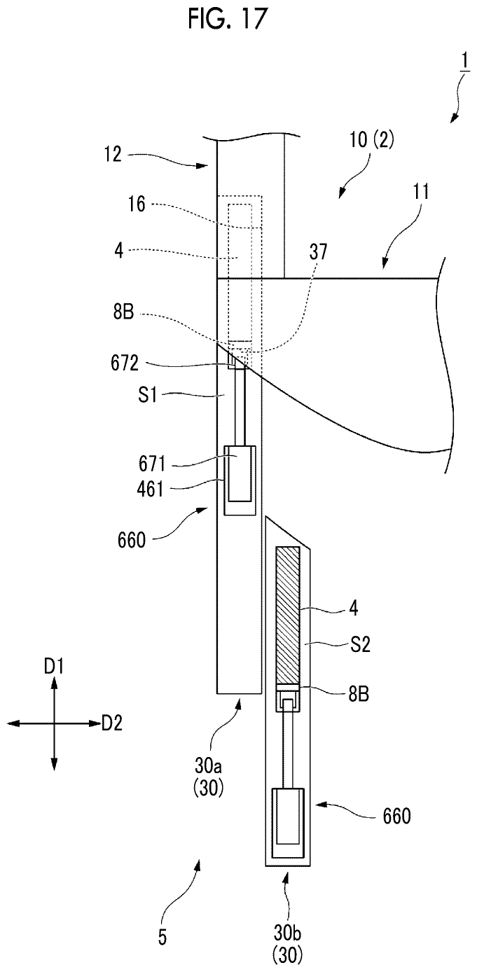

In addition, as illustrated in FIGS. 17 to 19, the actuator 560 may grip the battery 4 by means of a hook structure that engages with the battery 4.

In the present embodiment, the battery 4 has, for example, an engaging part 8B at a rear end thereof. The engaging part 8B includes an engaging base portion 35 and a protrusion portion 36. The engaging base portion 35 is provided at a rear end portion of the battery 4 in the advance/retreat direction D1. The protrusion portion 36 protrudes from the engaging base portion 35 to the rear side in the advance/retreat direction D1. An engaging groove 37 that penetrates the protrusion portion 36 in the up-down direction D3 is formed in the protrusion portion 36.

An actuator 660 includes an actuator base portion 461, an arm 462, a sub-actuator 671, and a hook 672. The hook 672 is a member capable of being engaged with the engaging groove 37 of the battery 4. The sub-actuator 671 changes the state of the hook 672 to a state in which the hook 672 is engaged with the engaging groove 37 of the battery 4 and a state in which the engagement with the engaging groove 37 is released. Hereinafter, the configuration of the actuator 660 will be described in detail.

The sub-actuator 671 is placed on the actuator base portion 461. The sub-actuator 671 includes a base portion 673 and an extendable portion 674. The base portion 673 is fixed to the actuator base portion 461. The extendable portion 674 extends from the base portion 673 to the front side in the advance/retreat direction D1. The extendable portion 674 is provided to be extendable and retractable in the advance/retreat direction D1.

The hook 672 is formed in a V shape that protrudes upward as viewed in the width direction D2. A rear end portion of the hook 672 is attached to a front end of the actuator base portion 461 via a shaft portion 675. The shaft portion 675 extends in a fourth direction D4. The hook 672 is rotatably provided around the shaft portion 675. A bent portion 672a of the hook 672 is attached to a front end of the extendable portion 674 of the sub-actuator 671.

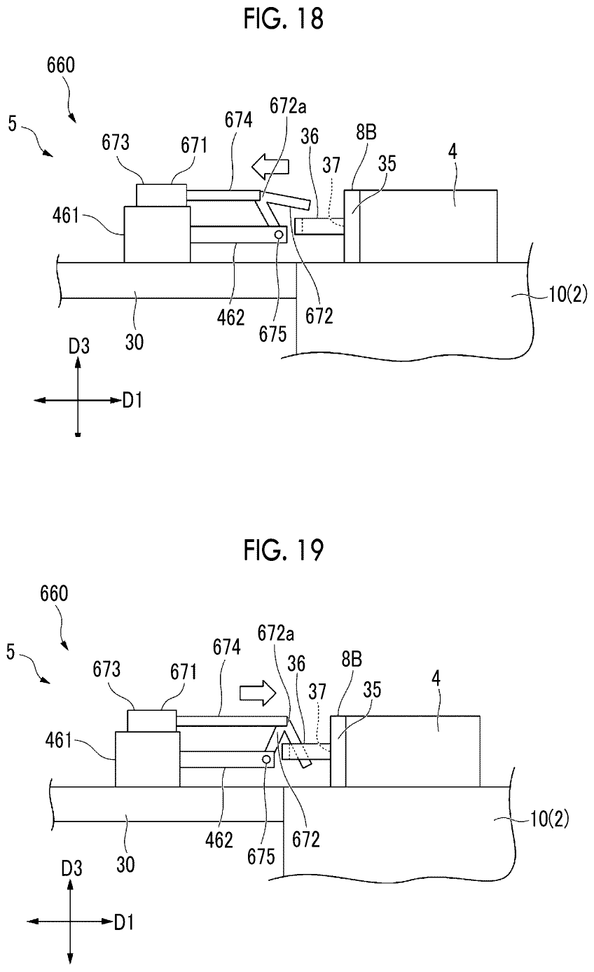

In a case where the actuator 660 grips the battery 4, first, the extendable portion 674 of the sub-actuator 671 illustrated in FIG. 18 is retracted to pull the hook 672 to the rear side in the advance/retreat direction D1. Then, as illustrated in FIG. 22, the extendable portion 674 of the sub-actuator 671 is extended, and the hook 672 is inserted into the engaging groove 37 of the battery 4 from above. In this way, the actuator 660 engages with the battery 4. In this state, the battery 4 can be drawn from the battery compartment 16 by moving the actuator 660 to the rear side in the advance/retreat direction D1.

As described above, in the present embodiment, the actuator 660 can grip the battery 4 by means of the engagement of the hook 672 with the engaging groove 37 of the battery 4. Accordingly, the actuator 660 can grip the battery 4 with a simple configuration without being affected by the material of the exterior of the battery 4.

The examples in which the actuators 460, 560, and 660 are used for the battery exchange device 5 according to the first embodiment have been described, but the present disclosure is not limited thereto. The actuators 460, 560, and 660 may be used for the battery exchange device 205 of the second embodiment and the battery exchange device 305 of the third embodiment.

### Additional Notes

For example, the battery exchange device 5, 205, or 305, the battery exchange system 1, 201, or 301, and the battery exchange method according to each embodiment are understood as follows.
(1) A battery exchange device 5, 205, or 305 according to a first aspect is a battery exchange device 5, 205, or 305 of a transport vehicle 2 including a battery compartment 16, the battery exchange device 5, 205, or 305 including a loading table 30 that is disposed to face the battery compartment 16 in an advance/retreat direction D1 of the transport vehicle 2 and that has a first region S1 and a second region S2 where a pair of batteries 4 are capable of being placed side by side in a width direction D2 of the transport vehicle 2 intersecting with the advance/retreat direction D1; a first moving mechanism 40 or 340 that moves the loading table 30 in the width direction D2 to cause the first region S1 and the second region S2 to selectively face the battery compartment 16 of the transport vehicle 2; a second moving mechanism 50 that brings the loading table 30 close to and away from the transport vehicle 2 in the advance/retreat direction D1; and an actuator 60, 260, 460, 560, or 660 that is capable of drawing a battery 4 from the battery compartment 16 of the transport vehicle 2 to the first region S1 and inserting a battery 4 on the second region S2 into the battery compartment 16.

Examples of the transport vehicle 2 include, for example, the automated driving forklift of the present embodiment, logistics vehicles, industrial vehicles, and electric vehicles.

Since the battery 4 in the battery compartment 16 is exchanged with the charged battery 4, the battery exchange device 5, 205, or 305 according to the present aspect operates as follows. The battery 4 that has been charged in advance is placed on the second region S2. First, the battery exchange device 5, 205, or 305 moves the loading table 30 in the width direction D2 and the advance/retreat direction D1 via the first moving mechanism 40 or 340 and the second moving mechanism 50 to dispose the first region S1 facing the battery compartment 16 to position the first region S1. Subsequently, the battery exchange device 5, 205, or 305 draws the battery 4 in the battery compartment 16 to the first region S1 via the actuator 60, 260, 460, 560, or 660. Subsequently, the battery exchange device 5, 205, or 305 moves the loading table 30 in the width direction D2 and the advance/retreat direction D1 via the first moving mechanism 40 or 340 and the second moving mechanism 50 to dispose the second region S2 facing the battery compartment 16 to position the second region S2. Then, the battery exchange device 5, 205, or 305 inserts the battery 4 on the second region S2 into the battery compartment 16 via the actuator 60, 260, 460, 560, or 660. In this way, the battery 4 is exchanged.
(2) The battery exchange device 5 or 305 according to a second aspect may be the battery exchange device 5 or 305 according to (1), in which a plurality of the actuators 60 are provided, and the plurality of actuators 60 include a first actuator 60a that is disposed to face the first region S1 in the advance/retreat direction D1, and a second actuator 60b that is disposed to face the second region S2 in the advance/retreat direction D1.

In the present embodiment, the battery 4 that has been charged in advance can be made to be gripped by the second actuator 60b. Accordingly, the battery exchange device 5 or 305 can insert the battery 4 into the battery compartment 16 via the second actuator 60b immediately after the second region S2 and the battery compartment 16 are disposed to face each other in the advance/retreat direction D1.
(3) The battery exchange device 205 according to a third aspect may be the battery exchange device 205 according to (1), in which only one actuator 260 is provided for one battery compartment 16.

Accordingly, the number of actuators 260 can be minimized.
(4) The battery exchange device 5, 205, or 305 according to a fourth aspect may be the battery exchange device 5, 205, or 305 according to any one of (1) to (3), in which a plurality of the battery compartments 16 are disposed side by side in the width direction D2 in the transport vehicle 2, and a region pair SP of the first region S1 and the second region S2 disposed side by side in the width direction D2 is provided for each battery compartment 16.

Accordingly, the battery exchange device 5, 205, or 305 can exchange the battery 4 in the plurality of battery compartments 16 with the charged battery 4 almost at the same time.
(5) The battery exchange device 5 or 205 according to a fifth aspect may be the battery exchange device 5 or 205 according to (4), in which the first moving mechanism 40 is provided for each region pair SP.

Accordingly, the battery exchange device 5 or 205 can control the movement of the loading table 30 in the width direction D2 for each region pair SP.
(6) The battery exchange device 305 according to a sixth aspect may be the battery exchange device 305 according to (4), in which the first moving mechanism 340 is provided to be capable of uniformly operating a plurality of the region pairs SP in the width direction D2, and a disposition relationship between the first region S1 and the second region S2 in the width direction D2 is set to be the same disposition relationship for all the plurality of region pairs SP uniformly operated by the first moving mechanism 340.

Accordingly, the battery exchange device 305 can move the plurality of region pairs SP via one first moving mechanism 340.
(7) The battery exchange device 5, 205, or 305 of a seventh aspect may be the battery exchange device 5, 205, or 305 according to any one of (1) to (6), in which the actuator 460 includes a magnet catch 463 that attracts the battery 4 by means of magnetic force.

In the present aspect, the actuator 460 can grip the battery 4 by means of magnetic force. Therefore, for example, in a case where a metal is used for the exterior of the battery 4, the actuator 460 can powerfully grip the battery 4.
(8) The battery exchange device 5, 205, or 305 of an eighth aspect may be the battery exchange device 5, 205, or 305 according to any one of (1) to (6), in which the actuator 560 has a suction cup 561 that is open on a front side in the advance/retreat direction D1 and that attracts the battery 4 by means of air pressure by creating a negative pressure inside the suction cup 561 in a state in which the suction cup 561 is brought into close contact with the battery 4.

In the present embodiment, the actuator 560 grips the battery 4 by means of air pressure. Therefore, the actuator 560 can grip the battery 4 regardless of the material of the exterior of the battery 4.
(9) The battery exchange device 5, 205, or 305 of a ninth aspect may be the battery exchange device 5, 205, or 305 according to any one of (1) to (6), in which the battery 4 has an engaging groove 37 formed on a rear side in the advance/retreat direction D1, and the actuator 660 includes a hook 672 that is engageable with the engaging groove 37 of the battery 4, and a sub-actuator 671 that changes the hook 672 between a state in which the hook 672 is engaged with the engaging groove 37 and a state in which the engagement of the hook 672 with the engaging groove 37 is released.

In the present aspect, the actuator 660 can grip the battery 4 by means of the engagement of the hook 672 with the engaging groove 37 of the battery 4. Accordingly, the actuator 660 can grip the battery 4 with a simple configuration without being affected by the material of the exterior of the battery 4.
(10) The battery exchange system 1, 201, or 301 according to a tenth aspect includes the battery exchange device 5, 205, or 305 according to any one of (1) to (9); and the transport vehicle 2.
(11) A battery exchange method according to an eleventh aspect is a battery exchange method for exchanging, by using the battery exchange device 5, 205, or 305 according to any one of (1) to (9), the battery 4 in the battery compartment 16 with the battery 4 on the second region S2, the battery exchange method including a step of moving the loading table 30 to dispose the first region S1 facing the battery compartment 16 to position the first region S1; a step of drawing the battery 4 in the battery compartment 16 onto the first region S1; a step of moving the loading table 30 to dispose the second region S2 facing the battery compartment 16 to position the second region S2; and a step of inserting the battery 4 on the second region S2 into the battery compartment 16.

### INDUSTRIAL APPLICABILITY

According to the battery exchange device, the battery exchange system, and the battery exchange method of the present disclosure, it is possible to shorten the time required for battery exchange.

### REFERENCE SIGNS LIST

1: battery exchange system
2: transport vehicle
3: control device
4: battery
5: battery exchange device
6: casing
6a: opening
7: detection unit
10: vehicle
11: vehicle body
12: straddle leg
13: running mechanism
13a: first drive wheel
13b: second drive wheel
14: mast
15: vehicle body frame
16: battery compartment
17: outer mast
18: inner mast
19: bracket
20: loading and unloading device
21: lift bracket
22: fork
23: fork base portion
24: fork claw portion
30: loading table
30a: first loading table
30b: second loading table
31: loading table body
32: movable rail
33: caster portion
34: ground surface
40: first moving mechanism
41: base
42: first ball screw
43: first linear guide unit
44: rail
45: guide portion
46: guide groove
50: second moving mechanism
51: table
52: second motor
53: second ball screw
60: actuator
60a: first actuator
60b: second actuator
61: actuator base portion
62: third motor
63: third ball screw
64: arm
65: tool changer
70: control unit
71: determination unit
72: first operation unit
73: second operation unit
74: actuator operation unit
201: battery exchange system
205: battery exchange device
260: actuator
301: battery exchange system
305: battery exchange device
340: first moving mechanism
1100: computer
1110: processor
1120: main memory
1130: storage
1140: interface
D1: advance/retreat direction
D2: width direction
D3: up-down direction
P: parking region
S1: first region
S2: second region
SP: region pair
460: actuator
461: actuator base portion
462: arm
463: magnet catch
464: flexible joint
8: iron plate
560: actuator
561: suction cup
8A: acrylic plate
660: actuator
671: sub-actuator
672: hook
672a: bent portion
673: base portion
674: extendable portion
675: shaft portion
8B: engaging part
35: engaging base portion
36: protrusion portion
37: engaging groove

1. A battery exchange device of a transport vehicle including a battery compartment, the battery exchange device comprising:
a loading table that is disposed to face the battery compartment in an advance/retreat direction of the transport vehicle and that has a first region and a second region where a pair of batteries are capable of being placed side by side in a width direction of the transport vehicle intersecting with the advance/retreat direction;
a first moving mechanism that moves the loading table in the width direction to cause the first region and the second region to selectively face the battery compartment of the transport vehicle;
a second moving mechanism that brings the loading table close to and away from the transport vehicle in the advance/retreat direction; and
an actuator that is capable of drawing the battery from the battery compartment of the transport vehicle to the first region and inserting the battery on the second region into the battery compartment.

2. The battery exchange device according to claim 1,
wherein a plurality of the actuators are provided, and
the plurality of actuators include
a first actuator that is disposed to face the first region in the advance/retreat direction, and a second actuator that is disposed to face the second region in the advance/retreat direction.

3. The battery exchange device according to claim 1,
wherein only one actuator is provided for one battery compartment.

4. The battery exchange device according to claim 1,
wherein a plurality of the battery compartments are disposed side by side in the width direction in the transport vehicle, and
a region pair of the first region and the second region disposed side by side in the width direction is provided for each battery compartment.

5. The battery exchange device according to claim 4,
wherein the first moving mechanism is provided for each region pair.

6. The battery exchange device according to claim 4,
wherein the first moving mechanism is provided to be capable of uniformly operating a plurality of the region pairs in the width direction, and
a disposition relationship between the first region and the second region in the width direction is set to be the same disposition relationship for all the plurality of region pairs uniformly operated by the first moving mechanism.

7. The battery exchange device according to claim 1,
wherein the actuator includes a magnet catch that attracts the battery by means of magnetic force.

8. The battery exchange device according to claim 1,
wherein the actuator includes a suction cup that is open on a front side in the advance/retreat direction and that attracts the battery by means of air pressure by creating a negative pressure inside the suction cup in a state in which the suction cup is brought into close contact with the battery.

9. The battery exchange device according to claim 1,
wherein the battery has an engaging groove formed on a rear side in the advance/retreat direction, and
the actuator includes
a hook that is engageable with the engaging groove of the battery, and
a sub-actuator that changes the hook between a state in which the hook is engaged with the engaging groove and a state in which the engagement of the hook with the engaging groove is released.

10. A battery exchange system comprising:
the battery exchange device according to claim 1; and
the transport vehicle.

11. A battery exchange method for exchanging, by using the battery exchange device according to claim 1, the battery in the battery compartment with the battery on the second region, the battery exchange method comprising:
a step of moving the loading table to dispose the first region facing the battery compartment to position the first region;
a step of drawing the battery in the battery compartment onto the first region;
a step of moving the loading table to dispose the second region facing the battery compartment to position the second region; and
a step of inserting the battery on the second region into the battery compartment.
